(19) United States
(12) Patent Application Publication
(10) Pub. No.: US 2026/0323315 A1
(43) Pub. Date: Oct. 15, 2026

(54) COMMUNICATION METHOD, USER EQUIPMENT, NETWORK NODE, MOBILE COMMUNICATION SYSTEM, CHIPSET FOR USER EQUIPMENT AND NON-TRANSITORY COMPUTER-READABLE MEDIUM

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/465,886

(22) Filed: Jan. 30, 2026

Related U.S. Application Data
(63) Continuation of application No. PCT/JP2024/027479, filed on Aug. 1, 2024.

(30) Foreign Application Priority Data
Aug. 1, 2023 (JP) 2023-125274

(51) Int. Cl. H04W 24/02; H04W 72/0453; H04W 76/20

(52) U.S. Cl. CPC H04W 24/02; H04W 72/0453; H04W 76/20

(57) ABSTRACT

A communication method is executed by a user equipment configured to be a Multi-Universal Subscriber Identity Module (USIM) UE in a mobile communication system. The communication method comprises: performing communication with a serving cell belonging to a first network; and transmitting, to a network node managing the serving cell, a message including information indicating a desire to change a configuration of the serving cell for communication in a second network, while the user equipment is in a radio resource control (RRC) connected state in the first network.

### RELATED APPLICATIONS

The present application is a continuation based on PCT Application No. PCT/JP2024/027479, filed on Aug. 1, 2024, which claims the benefit of Japanese Patent Application No. 2023-125274 filed on Aug. 1, 2023. The content of which is incorporated by reference herein in their entirety.

### TECHNICAL FIELD

The present disclosure relates to a communication method, a user equipment, and a network node used in a mobile communication system.

### BACKGROUND

The 3rd Generation Partnership Project (3GPP) (trademark; the same applies hereinafter) defines technical specifications for New Radio (NR) that is a fifth-generation (5G) radio access technology. NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

### Citation List

### Non-Patent Literature

Non-Patent Document 1: 3GPP Technical Specification: TS 38.300 V17.4.0

### SUMMARY

According to a first aspect, there is provided a communication method executed by a user equipment in a mobile communication system for providing a multicast/broadcast service (MBS), the communication method including the steps of: performing unicast communication with a serving cell and receiving a broadcast session from a non-serving cell in a radio resource control (RRC) connected state; and transmitting information indicating a desire to stop the unicast communication for reception of the broadcast session to a network node managing the serving cell.

According to a second aspect, there is provided a user equipment used in a mobile communication system for providing a multicast/broadcast service (MBS), the user equipment including: a receiver configured to perform unicast communication with a serving cell and receive a broadcast session from a non-serving cell in a radio resource control (RRC) connected state; and a transmitter configured to transmit information indicating a desire to stop the unicast communication for reception of the broadcast session to a network node managing the serving cell.

According to a third aspect, there is provided a network node used in a mobile communication system for providing a multicast/broadcast service (MBS), the network node including: a controller configured to perform unicast communication with a user equipment in a radio resource control (RRC) connected state in a serving cell managed by the network node; and a receiver configured to receive, from the user equipment receiving a broadcast session from a non-serving cell, information indicating a desire to stop the unicast communication for reception of the broadcast session.

### BRIEF DESCRIPTION OF THE DRAWINGS

FIG. 1 is a diagram illustrating a configuration example of a mobile communication system according to an embodiment.

FIG. 2 is a diagram illustrating a configuration example of a user equipment (UE) according to an embodiment.

FIG. 3 is a diagram illustrating a configuration example of a gNB (network node) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram for describing an operation scenario for the mobile communication system according to the embodiment.

FIG. 7 is a diagram illustrating a communication method executed by the UE according to the embodiment.

FIG. 8 is a diagram illustrating an example of a first operation pattern of the mobile communication system according to the embodiment.

FIG. 9 is a diagram illustrating an example of a second operation pattern of the mobile communication system according to the embodiment.

### DESCRIPTION OF EMBODIMENTS

A user equipment that performs unicast communication with a serving cell in a radio resource control (RRC) connected state may receive a broadcast session from a non-serving cell during the unicast communication with the serving cell. However, it may be difficult to perform such broadcast reception because limited reception resources (e.g., receivers) are available to the user equipment.

Therefore, an object of the present disclosure is to enable a user equipment to perform MBS reception from a non-serving cell.

According to an embodiment, a mobile communication system is described with reference to the drawings. In the description of the drawings, the same or similar parts are denoted by the same or similar reference signs.

### (1) System Configuration Example

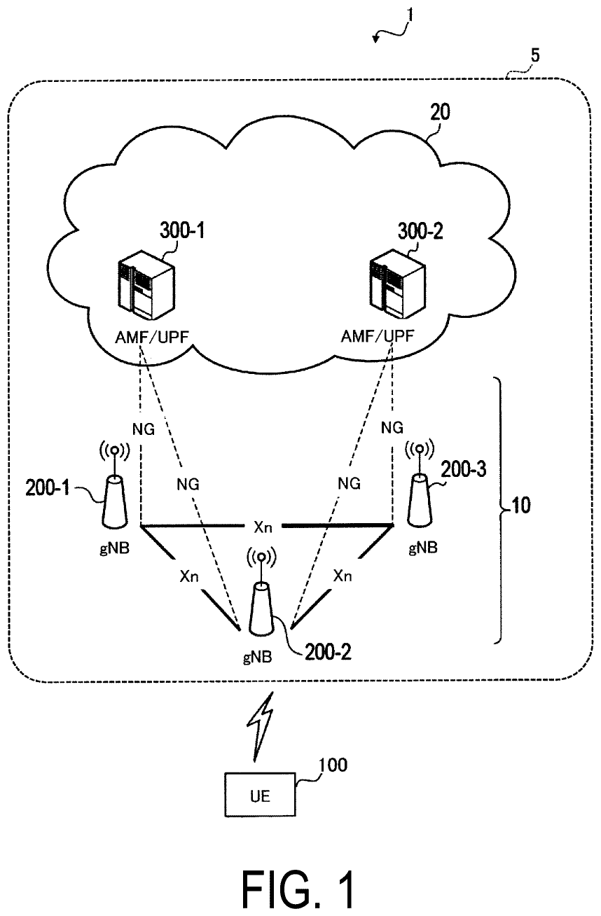

FIG. 1 is a diagram illustrating a configuration example of a mobile communication system 1 according to the embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes a base station 200 (referred to as a “gNB” in a 5G system), which is a type of network node. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

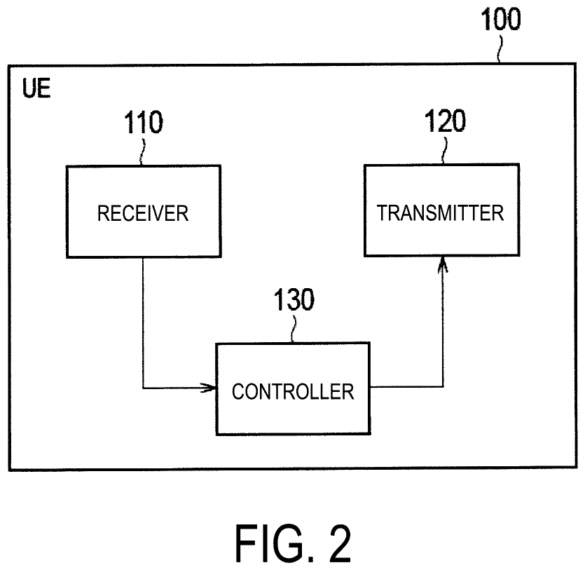

FIG. 2 is a diagram illustrating a configuration example of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The operations of the UE 100 described above and below may be operations under the control of a controller 230. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

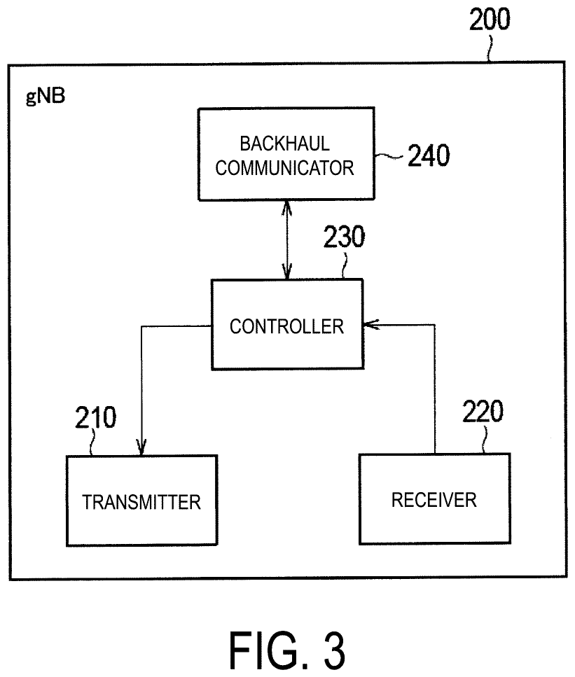

FIG. 3 is a diagram illustrating a configuration example of a gNB 200 (network node) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may be also performed under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface which is an interface between a base station and the core network. Note that the gNB 200 may include a Central Unit (CU) and a Distributed Unit (DU) (i.e., functions are divided), and both units may be connected via an F1 interface that is a fronthaul interface.

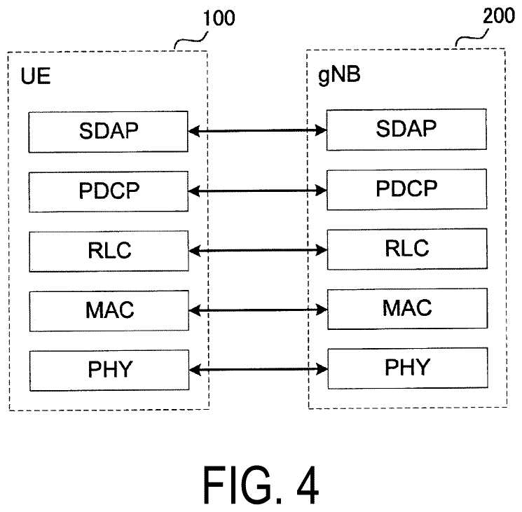

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

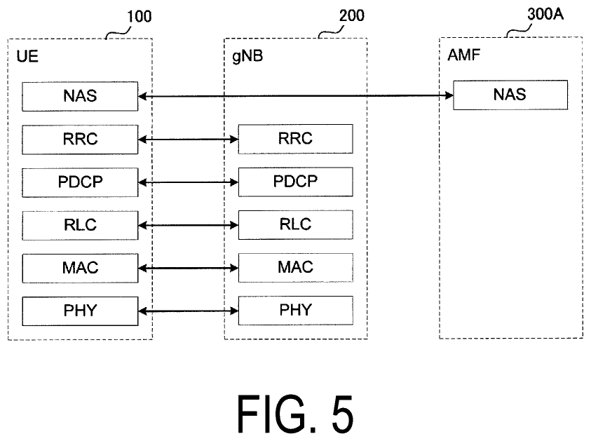

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as “NAS”), which is located above the RRC layer, performs session management, mobility management, and the like. NAS signaling is transmitted between the NAS layer of the UE 100 and the NAS layer of an AMF 300A. The UE 100 includes an application layer other than the protocol of the radio interface. The layer below the NAS layer is referred to as an AS layer (also simply referred to as “AS”).

### (2) Overview of MBS

The mobile communication system 1 can perform delivery with high resource efficiency by using the multicast/broadcast service (MBS).

### (2.1) MBS Broadcast

In a case of the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are delivered to the UE 100 using a broadcast session that is a type of MBS session. The UE 100 can receive the broadcast session in any state of the RRC idle state, the RRC inactive state, and the RRC connected state. Meanwhile, the MBS session can be identified by an MBS session ID, example, a temporary mobile group identity (TMGI)).

Point-to-Multipoint (PTM) delivery is applied to the broadcast communication service. For the PTM transmission, the gNB 200 delivers a single copy of an MBS packet to a set (group) of a plurality of UEs 100. For example, the gNB 200 uses a group-common PDCCH with a CRC scrambled by a Group RNTI (G-RNTI) that is a group-common RNTI to schedule a group-common PDSCH scrambled by the G-RNTI.

For the broadcast communication service, the UE 100 receives a broadcast session in the following procedure. First, the UE 100 receives system information block type 20 (SIB20) from the gNB 200. The SIB20 includes a configuration of a multicast control channel (MCCH), which is a type of logical channel. Second, the UE 100 receives the MCCH from the gNB 200 based on the SIB20. The MCCH includes a PTM configuration. The PTM configuration carries a configuration for a multicast traffic channel (MTCH), which is a type of logical channel, and a configuration of a broadcast multicast radio bearer (MRB), which is an MRB for broadcast session. The information transmitted by the MCCH may be referred to as MBS broadcast control information. Third, the UE 100 receives the MTCH based on the MCCH. The MTCH transmits a broadcast session (specifically, MBS data belonging to the broadcast session).

Note that the MCCH is a PTM downlink channel for transmitting the MBS broadcast control information associated with one or more MTCHs from the network 10 to the UE 100. The MTCH is a PTM downlink channel for transmitting MBS data of a multicast session and/or a broadcast session from the network 10 to the UE 100.

### (2.2) MBS Multicast

For a multicast communication service (also referred to as “MBS multicast”), the same service and the same specific content data are simultaneously provided to a specific UE set. That is, not every UE 100 in the multicast service area is permitted to receive data. The multicast communication service is delivered to the UE 100 using a multicast session that is a type of MBS session.

The UE 100 can receive a multicast session only after joining the multicast session (session join). The joining the multicast session may mean that the UE 100 is registered as being capable of receiving the multicast session in the network 5 (the CN 20).

For the multicast communication service, in 3GPP Release 17, only the UE 100 in the RRC connected state can receive a multicast session. On the other hand, in 3GPP Release 18, enhancement will be made such that the UE 100 in the RRC inactive state also can receive a multicast session.

### (3) Operation of Mobile Communication System

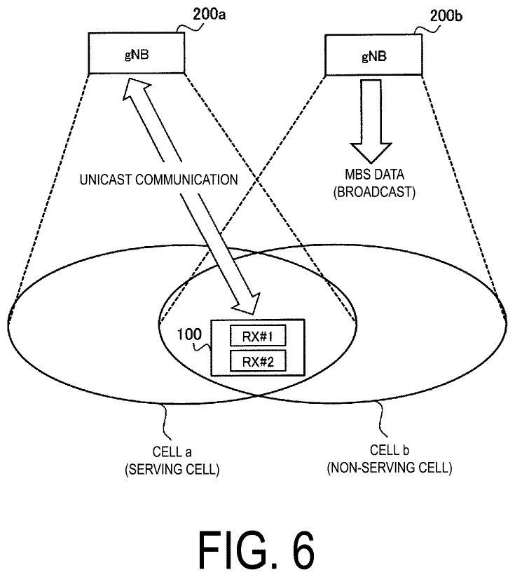

With reference to FIG. 6 to FIG. 9, an operation of the mobile communication system 1 according to the embodiment will be described.

### (3.1) Operation Scenario

FIG. 6 is a diagram for describing an operation scenario for the mobile communication system 1 according to the embodiment.

The UE 100 existing in an overlapping area of a cell a and a cell b is in an RRC connected state with respect to the cell a, and performs unicast communication with the cell a. That is, the cell a is a serving cell of the UE 100, and the cell b is a non-serving cell (neighboring cell) of the UE 100. The cell a may be operated at frequency (carrier frequency) a, and the cell b may be operated at frequency b different from frequency a. In the illustrated example, the cell a is managed by a gNB 200a, and the cell b is managed by a gNB 200b, which is different from the gNB 200a. However, the cell a and the cell b may be managed by the same gNB 200.

The UE 100 in an RRC connected state in the cell a performs unicast communication (specifically, data communication) with the cell a (gNB 200a). For example, the UE 100 is assigned a C-RNTI by the gNB 200a as an identifier for the RRC connection. The gNB 200a allocates radio resources (specifically, uplink communication resources and downlink communication resources) to the UE 100 by scheduling the UE 100.

The cell b (gNB 200b) transmits MBS data belonging to a broadcast session using PTM, that is, performs broadcast distribution using MBS broadcast. The UE 100 performs unicast communication with the cell a which is a serving cell, and receives a broadcast session from the cell b which is a non-serving cell (hereinafter, also simply referred to as “broadcast reception” or “MBS broadcast reception”). Here, the UE 100 performs broadcast reception by receiving the MTCH from the non-serving cell based on the MCCH from the non-serving cell.

For example, the UE 100 includes at least two receivers (RX), specifically, RX #1 and RX #2. The receiver 110 may be implemented as RX #1 and RX #2. The UE 100 uses one RX (for example, RX #1) for unicast communication and the other RX (for example, RX #2) for MBS broadcast reception.

Thus, in embodiments, the UE 100 performing unicast communication with a serving cell (cell a) in an RRC connected state may receive a broadcast session from a non-serving cell (cell b) during the unicast communication with the serving cell. However, it may be difficult to perform such broadcast reception because limited reception resources (for example, RX) are available to the UE 100.

For example, there may be a case where the MTCH can be received from the non-serving cell but the MCCH cannot be received from the non-serving cell, due to the load caused by unicast communication in the UE 100. As a result of the UE 100 receiving the MCCH change notification from the non-serving cell, it may be necessary to reduce the load of unicast communication in order to continue the MTCH reception in the non-serving cell. In addition, there may be a case where a frequency used to provide an MBS broadcast in a non-serving cell is changed.

### (3.2) Overview of Operation of Mobile Communication System

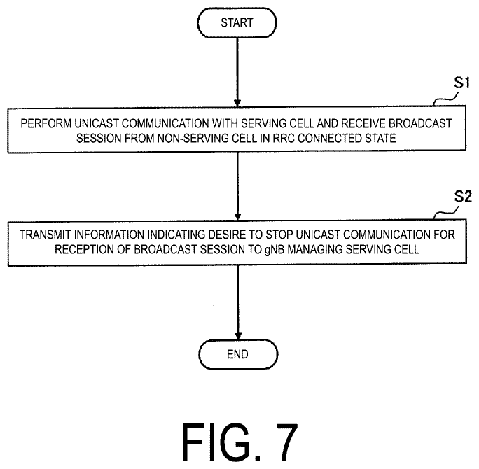

The embodiment facilitates the UE 100 performing MBS broadcast reception from a non-serving cell. FIG. 7 is a diagram illustrating a communication method executed by the UE 100 according to the embodiment. It is assumed that the UE 100 is in an RRC connected state in a serving cell (cell a).

In step S1, the UE 100 performs unicast communication with a serving cell (cell a) and receives a broadcast session from a non-serving cell (cell b).

In step S2, the UE 100 transmits information indicating a desire to stop unicast communication in order to receive a broadcast session to the gNB 200 (gNB 200a) that manages the serving cell (cell a). In the embodiment, the UE 100 may transmit an MBS interest indication message including the information to the gNB 200 (gNB 200a). Alternatively, the UE 100 may transmit a UE assistance information message including the information to the gNB 200 (gNB 200a). Meanwhile, both the MBS interest indication message (hereinafter also referred to as “MII message”) and the UE assistance information message (hereinafter also referred to as “UAI message”) are messages of the RRC layer (that is, RRC messages).

The UE 100 that performs such an operation includes a receiver 110 that performs unicast communication with a serving cell (cell a) and receives a broadcast session from a non-serving cell (cell b) in an RRC connected state, and a transmitter 120 that transmits information indicating a desire to stop the unicast communication in order to receive the broadcast session to the gNB 200 (gNB 200a) that manages the serving cell (cell a) (see FIG. 2).

On the other hand, the gNB 200 (gNB 200a) that manages the serving cell (cell a) includes a controller 230 that performs unicast communication with the UE 100 in the RRC connected state in the serving cell (cell a), and a receiver 220 that receives information indicating a desire to stop unicast communication in order to receive a broadcast session from the UE 100 that receives the broadcast session from the non-serving cell (cell b) (see FIG. 3).

In a first operation pattern of the embodiment, in step S2, the UE 100 transmits, to the gNB 200 (gNB 200a), stop desire information indicating a desire to temporarily stop unicast communication. The UE 100 may transmit, to the gNB 200 (gNB 200a), the stop desire information including information indicating a period during which unicast communication is temporarily stopped. During the period in which the unicast communication is temporarily stopped, the UE 100 may change the reception resource (for example, RX) used for reception of the unicast communication so as to be used for reception of the broadcast session. The UE 100 may change the reception resource so as to be used for the unicast communication in response to ending the period in which the unicast communication is temporarily stopped.

In a second operation pattern of the embodiment, in step S2, the UE 100 transmits, to the gNB 200 (gNB 200a), change desire information indicating a desire to change the serving cell (cell a). The UE 100 may transmit, to the gNB 200 (gNB 200a), change desire information including information indicating the frequency of the serving cell which is a change destination. The UE 100 may receive, from the gNB 200, an RRC reconfiguration message instructing to change the serving cell. Then, the UE 100 may change the reception resource (for example, RX) used for reception of the unicast communication so as to be used for reception of the broadcast session, in response changing the serving cell.

In the following description of the embodiment, the term “reception resource” is intended to be a term referring primarily to the receiver (RX) of the UE 100. However, the term “reception resource” may be a term referring to processing capability used for reception among processing capabilities (for example, processing capabilities (processing capacities) of a processor) of the UE 100 in addition to the RX of the UE 100 or instead of the RX of the UE 100.

### (4) Specific Example of Operation

An example of the first and second operation patterns of the mobile communication system 1 according to the embodiment will be described.

### (4.1) Example of First Operation Pattern

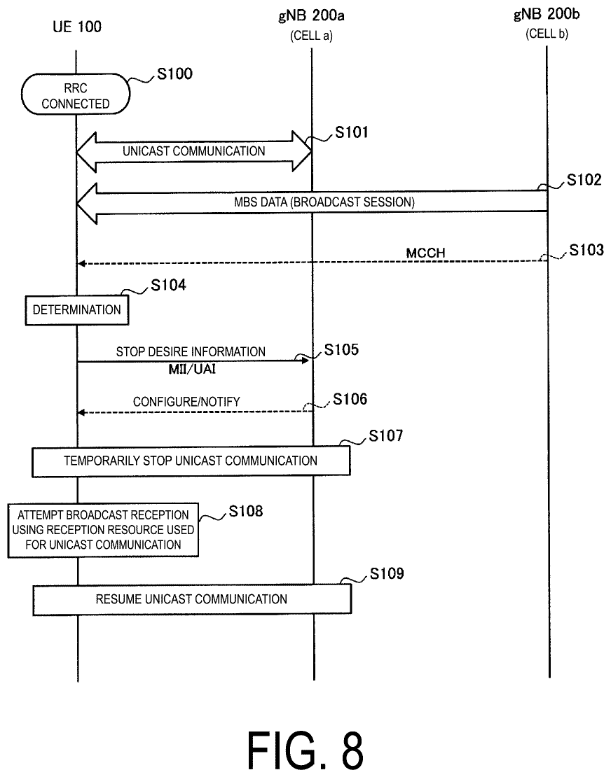

FIG. 8 is a diagram illustrating an example of the first operation pattern of the mobile communication system 1 according to the embodiment. In the first operation pattern, the UE 100 transmits, to the gNB 200 (gNB 200a), desire information for stopping unicast scheduling for a certain period of time.

In step S100, the UE 100 is in an RRC connected state in the serving cell (cell a).

In step S101, the UE 100 performs unicast communication with the serving cell (cell a).

In step S102, the UE 100 performs unicast communication with the serving cell (cell a) and performs MBS broadcast reception from the non-serving cell (cell b). For example, the UE 100 uses RX #1 for unicast communication and uses RX #2 for MBS broadcast reception.

In step S103, the UE 100 may receive an MCCH from the non-serving cell (cell b). The UE 100 may determine that an MBS broadcast frequency has changed based on the MCCH.

In step S104, the UE 100 determines to temporarily allocate the reception resource (for example, RX #1) used for unicast communication to the MBS broadcast. Meanwhile, when there are a plurality of RXs used in the unicast communication, the UE 100 may determine to temporarily allocate the plurality of RXs used for the unicast communication to the MBS broadcast. Alternatively, the UE 100 may determine to temporarily allocate the reception capability (reception processing amount) used for the unicast communication to the MBS broadcast.

For example, when detecting that the MBS broadcast frequency is changed, the UE 100 may determine to temporarily allocate the reception resource used for the unicast communication to the MBS broadcast. Under the premise that the UE 100 performs a search (full scan) to find the changed MBS broadcast frequency, the RX used for the unicast communication is temporarily assigned to the MBS broadcast and the search is performed, so that the search can be completed faster by using two RXs rather than one RX.

Alternatively, when measuring the reception quality of the MTCH and/or MCCH in the non-serving cell (cell b), and detecting that the reception quality has become worse than a threshold, the UE 100 may determine to temporarily allocate the reception resource used for the unicast communication to the MBS broadcast. The reception quality may be at least one of reference signal received power (RSRP), reference signal received quality (RSRP), signal-to-interference-plus-noise ratio (SINR), bit error rate (BER), block error rate (BLER), and packet error rate (PER). The threshold may be set from the gNB 200 (gNB 200a) to the UE 100. For example, the UE 100 can improve the reception sensitivity (reception quality) of the MBS broadcast reception by allocating the RX used for unicast to the MBS broadcast reception and performing diversity reception with 2RX.

Alternatively, when measuring the reception processing amount (processing load) in the non-serving cell (cell b) and detecting that the reception processing amount has exceeded a threshold, the UE 100 may determine to temporarily allocate the reception resource used for the unicast communication to the MBS broadcast. For example, when the sub-carrier spacing (SCS) of the MBS broadcast is widened, that is, the symbol length is shortened, it is assumed that the processing load of the digital signal processing increases, the MBS broadcast reception cannot be processed, and a packet error occurs. In such a case, the reception quality of the MBS broadcast reception can be improved by allocating the processing capability used for the unicast communication to the MBS broadcast reception.

In step S105, the UE 100 transmits an MII message (or a UAI message) including stop desire information indicating a desire (request) to temporarily stop the unicast communication to the cell a (gNB 200a) which is a serving cell. The gNB 200a receives the message.

Here, the stop desire information may include time information indicating a period during which the unicast communication is to be stopped. The time information may include at least one piece of information indicating a start timing of a period during which the unicast communication is stopped and information indicating a time length (duration) during which the unicast communication is stopped. The time information may include information indicating the end timing of the period during which the unicast communication is stopped.

The stop desire information may include cause information indicating a reason for temporarily stopping the unicast communication. The cause information may be information indicating the MBS broadcast reception as a reason.

In step S106, when accepting the desire of step S105, the gNB 200a may transmit a notification or configuration indicating the acceptance to the UE 100.

The configuration may be a suspend configuration for temporarily transitioning the UE 100 to an RRC inactive state.

The notification or configuration may include time information indicating a period during which the unicast communication is stopped. The time information may include at least one of information indicating the start timing of a period during which the unicast communication is stopped and information indicating a time length (duration) during which the unicast communication is stopped. The information indicating the time length may be a timer value set in a timer to be described later. The time information may include information indicating the end timing of the period during which the unicast communication is stopped.

In step S107, the UE 100 stops the unicast communication when transmitting the stop desire information in step S105 or when receiving the notification or configuration in step S106. The UE 100 may start a timer that specifies the time to stop the unicast communication.

In step S108, that is, during a period in which the unicast communication is temporarily stopped, the UE 100 changes the reception resource (for example, RX and/or processing capability) used for the unicast communication to be used for MBS broadcast reception. That is, the UE 100 attempts to receive the MBS broadcast using the reception resources used for the unicast communication.

For example, on the premise that the MBS broadcast frequency will be changed, the UE 100 may temporarily allocate the RX used for the unicast communication to the MBS broadcast and perform a search. Alternatively, the UE 100 may allocate the RX used for the unicast communication to MBS broadcast reception and perform diversity reception with 2RX on the premise that the reception qualities of the MTCH and/or MCCH in the non-serving cell (cell b) become worse than a threshold. Alternatively, the UE 100 may allocate the processing capability used for the unicast communication to MBS broadcast reception on the premise that the reception processing amount (processing load) in the non-serving cell (cell b) has become greater than the threshold.

In step S109, that is, when ending the period during which the unicast communication is temporarily stopped (for example, when the timer expires), the UE 100 changes the reception resource allocated to the MBS broadcast reception to be used for the unicast communication, and returns (resumes) the reception resource to the original unicast communication state.

In this operation example, when the problem is not solved even after temporarily allocating the reception resource to the MBS broadcast reception in step S108, the UE 100 may perform the following operation.

For example, when prioritizing the MBS broadcast reception, the UE 100 may transmit, to the gNB 200a, release assistance information (RAI) indicating a desire to transition from the RRC connected state to the RRC idle state or the RRC inactive state. Here, the UE 100 may transmit cause information indicating the reason for prioritizing the MBS broadcast reception together with the RAI.

Depending on the RAI, the gNB 200a transitions the UE 100 from the RRC connected state to the RRC idle state or the RRC inactive state. As a result, the reception resource used for the unicast communication is released, and the reception resource becomes available for MBS broadcast reception.

On the other hand, when the problem is not solved even after temporarily allocating receiving resources to MBS broadcast reception in step S108 and the unicast communication is prioritized, the UE 100 may stop the MBS broadcast reception and discard the broadcast MRB.

### (4.2) Example of Second Operation Pattern

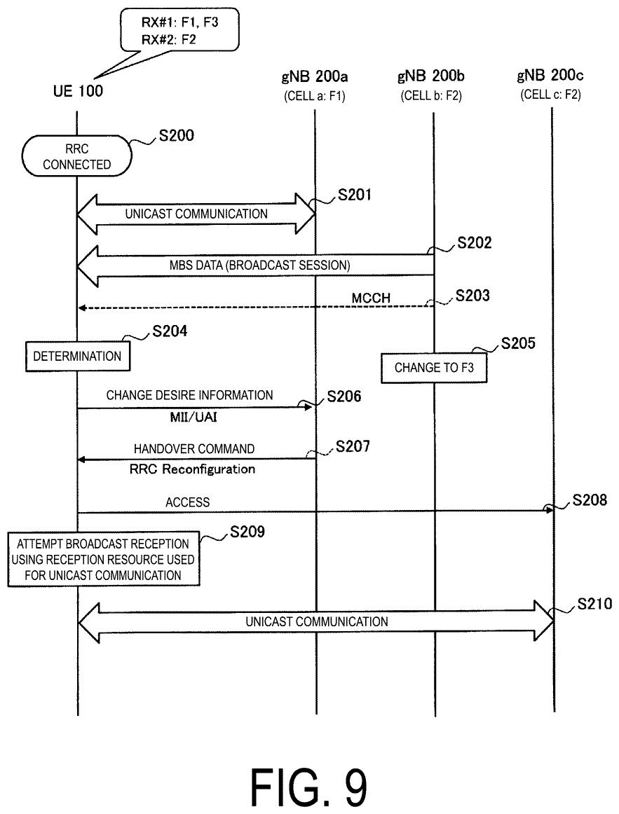

FIG. 9 is a diagram illustrating an example of a second operation pattern of the mobile communication system 1 according to the embodiment. In the second operation pattern, the UE 100 transmits information indicating a desire to change the serving cell to the gNB 200a.

In this operation example, it is assumed that UE 100 has two RXs, RX #1 and RX #2, the corresponding frequencies of RX #1 are F1 and F3, and the corresponding frequency of RX #2 is F2. Under such an assumption, the UE 100 is assumed to receive unicast at F1 (RX #1) and receive MBS broadcast at F2 (RX #2). Thereafter, when the MBS broadcast is changed from F2 to F3, it may be necessary to allocate RX #1 to the MBS broadcast in the UE 100.

In step S200, the UE 100 is in an RRC connected state in the serving cell (cell a) operated at frequency F1.

In step S201, the UE 100 performs the unicast communication with the serving cell (cell a) operated in frequency F1.

In step S202, the UE 100 performs the unicast communication with the serving cell (cell a) operated at frequency F1, and performs MBS broadcast reception from the non-serving cell (cell b) operated at frequency F2. For example, the UE 100 uses RX #1 for unicast communication with the serving cell (cell a) and uses RX #2 for receiving an MBS broadcast from the non-serving cell (cell b).

In step S203, the UE 100 may receive an MCCH from the non-serving cell (cell b). The UE 100 may determine, based on the MCCH, that the MBS broadcast frequency is changed from frequency F2 to frequency F3.

In step S204, the UE 100 determines to continuously allocate RX #1 used for unicast communication with the serving cell (cell a) to the MBS broadcast. In this operation example, the UE 100 has two RXs, RX #1 and RX #2, the corresponding frequencies of RX #1 are F1 and F3, and the corresponding frequency of RX #2 is F2. When the MBS broadcast frequency is changed from frequency F2 to frequency F3, the UE 100 determines that in order to receive the MBS broadcast, the use of RX #1 corresponding to frequency F3 should be changed from unicast communication to MBS broadcast reception. Further, the UE 100 determines to change the use of RX #2 corresponding to frequency F2 from MBS broadcast reception to unicast communication.

In step S205, the gNB 200b changes the MBS broadcast frequency providing the broadcast session from frequency F2 to frequency F3.

In step S206, the UE 100 transmits an MII message (or a UAI message) including change desire information indicating a desire (request) to change the serving cell to the cell a (gNB 200a) which is a serving cell. The gNB 200a receives the message. The change desire information may include frequency information indicating the frequency of the cell which is a handover destination, and may be a desire for handover (request for handover) to the cell of the frequency. The change desire information may include cause information indicating a reason for changing the serving cell. The cause information may be information indicating the MBS broadcast reception as a reason.

In step S207, when accepting the desire of step S206, the gNB 200a transmits an RRC Reconfiguration message equivalent to a handover command to the UE 100, and changes the serving cell. The RRC Reconfiguration message includes information for designating the cell c operated at frequency F2 as a target of the handover. The cell c may be a cell of a gNB 200c.

In step S207, in response to the reception of the handover command (RRC Reconfiguration message) in step S207, the UE 100 accesses the cell c operated at frequency F2, and changes the serving cell from the cell a to the cell c. Here, the UE 100 changes RX #2 so as to be used for the unicast communication with the cell c.

In step S209, the UE 100 attempts to receive the MBS broadcast provided at frequency F3 through RX #1 used for unicast communication, and performs MBS broadcast reception from the non-serving cell (cell b) using RX #1.

In step S210, the UE 100 performs unicast communication with the cell c (gNB 200c), which is a new serving cell, using RX #2.

### (5) Variations

In the above-described embodiment, the cell a (gNB 200a), which is a serving cell, may belong to a first public land mobile network (PLMN), and the cell b (gNB 200b), which is a non-serving cell, may belong to a second PLMN different from the first PLMN. Such a relationship of PLMNs is referred to as an inter-PLMN.

The UE 100 may include a Subscriber Identity Module (SIM) corresponding to a PLMN 5a, and may not include a SIM corresponding to a PLMN 5b. For example, the cell b (gNB 200b) may provide the broadcast session in a Receive-Only Mode (ROM) and/or Free-To-Air (FTA). Such an MBS broadcast service may be a broadcast-only service such as general television broadcasts or radio broadcasts. The ROM is a mode allowing the UE 100 to perform MBS reception even if the UE 100 does not include a Subscriber Identity Module (SIM) and/or does not have a service contract with an operator (PLMNs). The FTA is an application (service) for enabling the broadcasting of free broadcast content. The FTA may be one aspect of the ROM. The MBS broadcast that is provided in the FTA may be provided to be available to all users who are not mobile subscribers.

Alternatively, the UE 100 may include both a SIM corresponding to the first PLMN and a SIM corresponding to the second PLMN. Such a UE 100 is also referred to as a Multi-SIM UE or a Multi-Universal Subscriber Identity Module (USIM) UE. The UE 100 receives an MBS broadcast that is provided in the ROM or FTA from the second PLMN.

### (6) Other Embodiments

In the above-described embodiment, a scenario in which the UE 100 receives an MBS broadcast from a non-serving cell has been assumed, but a scenario in which the UE 100 receives an MBS multicast from a non-serving cell may be assumed. Therefore, the reception scenario for broadcast (broadcast session) in the operation according to the above embodiment may be diverted to the reception scenario for multicast (multicast session).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although an example in which the network node is an NR base station (gNB) has been described in the embodiments and examples described above, the network node may also be an LTE base station (eNB) or a 6G base station. In addition, the network node may be a relay node such as an Integrated Access and Backhaul (IAB) node. The network node may be a DU of the IAB node. The UE 100 may be a Mobile Termination (MT) of the IAB node.

That is, the UE 100 may be a terminal function unit (a type of communication module) for a base station to control a repeater that performs signal relay. Such a terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the NB 200 (the network node) may be implemented in a circuitry or a processing circuitry programmed to perform the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (7) Supplement

Features relating to the embodiments described above are described below as supplementary notes.

### Supplementary Note 1

A communication method executed by a user equipment in a mobile communication system for providing a multicast/broadcast service (MBS), the communication method including the steps of:
performing unicast communication with a serving cell and receiving a broadcast session from a non-serving cell in a radio resource control (RRC) connected state; and
transmitting information indicating a desire to stop the unicast communication for reception of the broadcast session to a network node managing the serving cell.

### Supplementary Note 2

The communication method according to Supplementary Note 1, wherein the transmitting includes transmitting, to the network node, stop desire information indicating a desire to temporarily stop the unicast communication.

### Supplementary Note 3

The communication method according to Supplementary Note 2, wherein transmitting of the stop desire information includes transmitting, to the network node, the stop desire information including information indicating a period during which the unicast communication is temporarily stopped.

### Supplementary Note 4

The communication method according to Supplementary Note 2 or 3, further including changing a reception resource used for reception of the unicast communication so as to be used for reception of the broadcast session, in a period during which the unicast communication is temporarily stopped.

### Supplementary Note 5

The communication method according to Supplementary Note 4, further including changing the reception resource so as to be used for the unicast communication in response to ending the period during which the unicast communication is temporarily stopped.

### Supplementary Note 6

The communication method according to Supplementary Note 1, wherein the transmitting includes transmitting, to the network node, change desire information indicating a desire to change the serving cell.

### Supplementary Note 7

The communication method according to Supplementary Note 6, wherein transmitting of the change desire information includes transmitting, to the network node, the change desire information including information indicating a frequency of a serving cell which is a change destination.

### Supplementary Note 8

The communication method according to Supplementary Note 6 or 7, further including the steps of:
receiving, from the network node, an RRC reconfiguration message instructing to change the serving cell; and
changing a reception resource used for reception of the unicast communication so as to be used for reception of the broadcast session, in response to changing the serving cell

### Supplementary Note 9

The communication method according to Supplementary Notes 1 to 8, wherein the transmitting includes transmitting an MBS interest indication message including the information to the network node.

### Supplementary Note 10

A user equipment used in a mobile communication system for providing a multicast/broadcast service (MBS), the user equipment including:
a receiver configured to perform unicast communication with a serving cell and receive a broadcast session from a non-serving cell in a radio resource control (RRC) connected state; and
a transmitter configured to transmit information indicating a desire to stop the unicast communication for reception of the broadcast session to a network node managing the serving cell.

### Supplementary Note 11

A network node used in a mobile communication system for providing a multicast/broadcast service (MBS), the network node including:
a controller configured to perform unicast communication with a user equipment in a radio resource control (RRC) connected state in a serving cell managed by the network node; and
a receiver configured to receive, from the user equipment receiving a broadcast session from a non-serving cell, information indicating a desire to stop the unicast communication for reception of the broadcast session.

### REFERENCE SIGNS

1: Mobile communication system
5: Network
10: RAN
20: CN
100: User equipment (UE)
110: Receiver
120: Transmitter
130: Controller
200: gNB (network node)
210: Transmitter
220: Receiver
230: Controller
240: Backhaul communicator

1. A communication method executed by a user equipment configured to be a Multi-Universal Subscriber Identity Module (USIM) UE in a mobile communication system, the communication method comprising:
performing communication with a serving cell belonging to a first network; and
transmitting, to a network node managing the serving cell, a message including information indicating a desire to change a configuration of the serving cell for communication in a second network, while the user equipment is in a radio resource control (RRC) connected state in the first network.

2. The communication method according to claim 1, wherein the message includes frequency information desired by the user equipment for the communication in the second network.

3. A user equipment configured to be a Multi-Universal Subscriber Identity Module (USIM) UE, the user equipment comprising:
a processor configured to perform communication with a serving cell belonging to a first network; and
a transmitter configured to transmit, to a network node managing the serving cell, a message including information indicating a desire to change a configuration of the serving cell for communication in a second network, while the user equipment is in a radio resource control (RRC) connected state in the first network.

4. A network node used in a mobile communication system, the network node comprising:
a processor configured to perform communication with a user equipment configured to be a Multi-Universal Subscriber Identity Module (USIM) UE, the user equipment configured to be in a radio resource control (RRC) connected state in a serving cell, the serving cell managed by the network node and belonging to a first network; and
a receiver configured to receive, from the user equipment in the RRC connected state in the first network, a message including information indicating a desire to change a configuration of the serving cell for communication in a second network.

5. A mobile communication system comprising:
the user equipment according to claim 3; and
a network node managing the serving cell and configured to receive the message.

6. A chipset for a user equipment configured to be a Multi-Universal Subscriber Identity Module (USIM) UE, the chipset configured to execute processing of:
performing communication with a serving cell belonging to a first network; and
transmitting, to a network node managing the serving cell, a message including information indicating a desire to change a configuration of the serving cell for communication in a second network, while the user equipment is in a radio resource control (RRC) connected state in the first network.

7. A non-transitory computer-readable medium comprising, stored thereupon, computer program instructions for execution by a user equipment configured to be a Multi-Universal Subscriber Identity Module (USIM) UE, the program instructions being configured to cause the user equipment to execute processing of:
performing communication with a serving cell belonging to a first network; and
transmitting, to a network node managing the serving cell, a message including information indicating a desire to change a configuration of the serving cell for communication in a second network, while the user equipment is in a radio resource control (RRC) connected state in the first network.
